(19) United States
(12) Patent Application Publication
(10) Pub. No.: US 2016/0260953 A1
(43) Pub. Date: Sep. 8, 2016

(54) SECONDARY BATTERY AND METHOD OF MANUFACTURING THE SAME

(71) Applicant: SAMSUNG SDI CO., LTD., Yongin-si (KR)

(72) Inventors: Youngchang Lim, Yongin-si (KR); Jeawoan Lee, Yongin-si (KR); Joonsup Kim, Yongin-si (KR); In-Seop Byun, Yongin-si (KR); Taegon Kim, Yongin-si (KR)

(21) Appl. No.: 15/042,009

(22) Filed: Feb. 11, 2016

(30) Foreign Application Priority Data
Mar. 4, 2015 (KR) 10-2015-0030549

(51) Int. Cl. H01M 2/26; H01M 2/08; H01M 10/04; H01M 2/30

(52) U.S. Cl. CPC H01M 2/26; H01M 2/30; H01M 2/08; H01M 10/0431; H01M 2220/30

(57) ABSTRACT

A secondary battery includes: an electrode assembly including a first electrode plate, a second electrode plate, and a separator between the first electrode plate and the second electrode plate; a first lead and a second lead on one end of the first electrode plate and one end of the second electrode plate, respectively; and a first electrode tab and a second electrode tab connected to the first lead and the second lead, respectively, and the first electrode tab and the second electrode tab are integral with each other.

### CROSS-REFERENCE TO RELATED APPLICATION

This application claims priority to and the benefit of Korean Patent Application No. 10-2015-0030549, filed on Mar. 4, 2015 in the Korean Intellectual Property Office, the entire content of which is incorporated herein by reference.

### BACKGROUND

1. Field

Aspects of embodiments of the present invention relate to a secondary battery and a method of manufacturing a secondary battery.

2. Description of the Related Art

Due to the development of technology in the field of electronics, the market for various mobile electronic devices, such as mobile phones, game devices, portable multimedia players (PMPs), MPEG audio layer-3 (MP3) players, smartphones, smartpads, e-book terminal equipment, flexible tablet computers, and mobile medical devices that attach to the body, has greatly grown.

In order to form a secondary battery to have a small volume, an electrode plate is generally wound in the form of a roll. Thus, a plurality of electrode plates are alternately stacked according to polarities, and the stacked state is referred to as a “jelly roll,” and electrode plates having the same polarity are electrically connected to each other such that two electrodes of the secondary battery can be formed.

Many secondary batteries have been recently developed to be used for powering of mobile electronic devices, because they are rechargeable and can be made to have a small size and a large capacity. In particular, for the convenience of mobility, as secondary batteries are gradually reduced or minimized in size, a demand for subminiature secondary batteries is increasing.

### SUMMARY

According to an aspect of one or more exemplary embodiments of the present invention, a secondary battery is provided. According to another aspect of one or more exemplary embodiments of the present invention, a method of manufacturing a secondary battery is provided.

Additional aspects and features of embodiments of the present invention will be set forth in part in the description which follows and, in part, will be apparent from the description, or may be learned by practice of the presented embodiments.

According to one or more exemplary embodiments of the present invention, a secondary battery includes: an electrode assembly including a first electrode plate, a second electrode plate, and a separator between the first electrode plate and the second electrode plate; a first lead and a second lead on one end of the first electrode plate and one end of the second electrode plate, respectively; and a first electrode tab and a second electrode tab connected to the first lead and the second lead, respectively, wherein the first electrode tab and the second electrode tab are integral with each other. The electrode assembly may be wound and have a jelly roll shape.

Each of the first lead and the second lead may include a same material as a material of the first electrode plate and the second electrode plate, respectively.

The first electrode tab and the second electrode tab may be integrally connected to each other through a polymer film.

Each of the first lead and the second lead may have a smaller thickness than that of the first electrode tab and the second electrode tab.

The secondary battery may further include a sealing portion accommodating the electrode assembly, wherein the sealing portion includes a first sealing portion having an accommodation space to accommodate the electrode assembly, and a second sealing portion that covers the accommodation space and is coupled to the first sealing portion.

The first electrode tab and the second electrode tab may be protruded to the outside of the sealing portion in a sealed state.

Each of the first electrode tab and the second electrode tab may include a bending portion in a bent shape, and the bending portion may be arranged in the sealing portion.

According to one or more exemplary embodiments of the present invention, a method of manufacturing a secondary battery includes: providing a first electrode plate, a second electrode plate, and a separator between the first electrode plate and the second electrode plate; arranging a first lead and a second lead on the first electrode plate and the second electrode plate, respectively, in a lengthwise direction of the secondary battery; preparing an electrode assembly having a jelly roll shape by winding the first electrode plate, the second electrode plate, and the separator; and connecting a first electrode tab and a second electrode tab to the first lead and the second lead, respectively, wherein the first electrode tab and the second electrode tab are integral with each other.

Each of the first lead and the second lead may include a same material as a material of the first electrode plate and the second electrode plate, respectively.

The first electrode tab and the second electrode tab may be integrally connected with each other using a polymer film.

The method may further include bending the first electrode tab and the second electrode tab that are integral with each other, after the first electrode tab and the second electrode tab are connected to the first lead and the second lead, respectively. The method may further include providing a sealing portion having an accommodation space; placing the electrode assembly, the first lead, and the second lead in the accommodation space; and sealing the sealing portion such that the first electrode tab and the second electrode tab protrude outside the sealing portion.

### BRIEF DESCRIPTION OF THE DRAWINGS

These and/or other aspects will become apparent and more readily appreciated from the following description of some exemplary embodiments, taken in conjunction with the accompanying drawings, in which:

FIG. 1 is a schematic perspective view of a secondary battery according to an exemplary embodiment of the present invention;

FIG. 2 is a schematic cross-sectional view of an electrode assembly of the secondary battery illustrated in FIG. 1;

FIG. 3 is a schematic side view of an electrode assembly having a jelly roll shape of the secondary battery of FIG. 1;

FIG. 4 is a schematic top view of the electrode assembly illustrated in FIG. 3; and

FIGS. 5 and 6 are schematic side views of an electrode assembly and a secondary battery, respectively, according to another exemplary embodiment of the present invention.

### DETAILED DESCRIPTION

Reference will now be made in further detail to some exemplary embodiments, examples of which are illustrated in the accompanying drawings, wherein like reference numerals refer to like elements throughout. In this regard, embodiments of the present invention may have different forms and should not be construed as being limited to the descriptions of some exemplary embodiments set forth herein. Accordingly, the exemplary embodiments are merely described below, by referring to the figures, to explain aspects and features of embodiments of the present invention, and the drawings and description are to be regarded as illustrative in nature and not restrictive.

Some exemplary embodiments will be described below in more detail with reference to the accompanying drawings. Those components that are the same or are in correspondence are referenced using the same reference numeral regardless of the figure number, and redundant explanations are omitted.

It will be understood that although the terms “first,” “second,” etc. may be used herein to describe various components, these components should not be limited by these terms. These components are only used to distinguish one component from another.

As used herein, the singular forms “a,” “an,” and “the” are intended to include the plural forms as well, unless the context clearly indicates otherwise.

It will be further understood that the terms “comprises” and/or “comprising” used herein specify the presence of stated features or components, but do not preclude the presence or addition of one or more other features or components.

It will be understood that when a layer, region, or component is referred to as being “formed on” another layer, region, or component, it can be directly or indirectly formed on the other layer, region, or component. That is, for example, intervening layers, regions, or components may be present.

Sizes of elements in the drawings may be exaggerated for convenience of explanation. In other words, since sizes and thicknesses of components in the drawings may be arbitrarily illustrated for convenience of explanation, embodiments of the present invention are not limited thereto.

When a certain embodiment may be implemented differently, a specific process order may be performed differently from the described order. For example, two consecutively described processes may be performed substantially at the same time or performed in an order opposite to the described order. Expressions such as “at least one of,” when preceding a list of elements, modify the entire list of elements and do not modify the individual elements of the list.

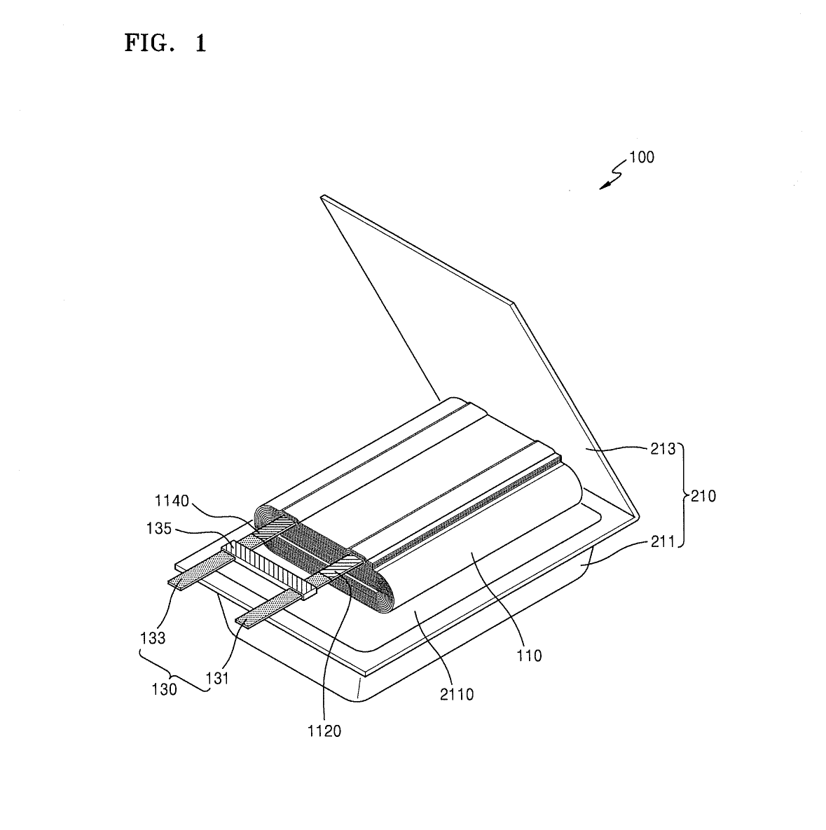

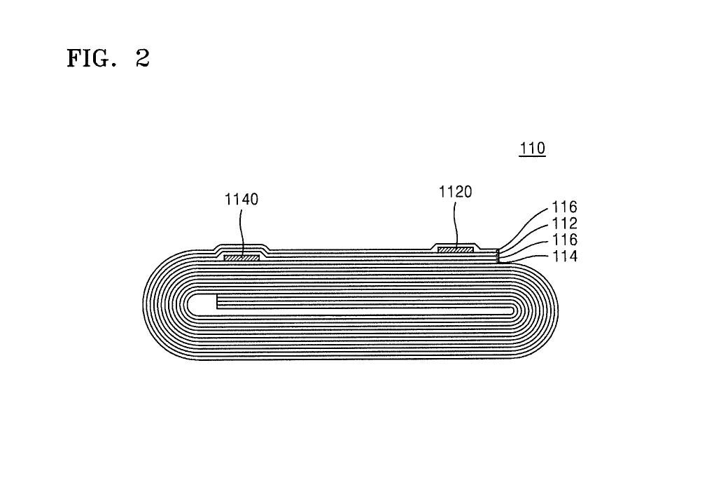

FIG. 1 is a schematic perspective view of a secondary battery 100 according to an exemplary embodiment of the present invention; and FIG. 2 is a cross-sectional view of an electrode assembly of the secondary battery 100 illustrated in FIG. 1.

Referring to FIGS. 1 and 2, the secondary battery 100 according to an exemplary embodiment may include an electrode assembly 110, a sealing portion 210 that accommodates the electrode assembly 110, and an integrally-formed electrode tab 130 connected to the electrode assembly 110.

The electrode assembly 110 may include a first electrode plate 112, a second electrode plate 114, and a separator 116 between the first electrode plate 112 and the second electrode plate 114. For example, the electrode assembly 110 may include a structure in which a plurality of first electrode plates 112, a plurality of separators 116, and a plurality of second electrode plates 114 are repeatedly stacked.

The first electrode plate 112 may be one of a positive electrode film and a negative electrode film. When the first electrode plate 112 is a positive electrode film, the second electrode plate 114 may be a negative electrode film. Alternatively, when the first electrode plate 112 is a negative electrode film, the second electrode plate 114 may be a positive electrode film.

The first electrode plate 112 may include a first metal current collector (not shown), a first active material portion (not shown) formed by coating a surface of the first metal current collector with a first active material (not shown), and a first uncoated portion (not shown) that is not coated with the first active material. Similarly, the second electrode plate 114 may include a second metal current collector (not shown), a second active material portion (not shown) formed by coating a surface of the second metal current collector with a second active material (not shown), and a second uncoated portion (not shown) that is not coated with the second active material. When the first electrode plate 112 is a positive electrode film, the first metal current collector may be a positive electrode current collector, and the first active material portion may be a positive electrode active material portion. When the second electrode plate 114 is a negative electrode film, the second metal current collector may be a negative electrode current collector, and the second active material portion may be a negative electrode active material portion.

The positive electrode current collector, in one or more embodiments, may be a metal, such as aluminum (Al), stainless steel, titanium (Ti), or a combination of materials selected therefrom. The positive electrode active material portion may include a positive electrode active material, a binder, and a conductive agent.

The positive electrode active material may be a material that may reversibly absorb and discharge lithium ions. For example, the positive electrode active material may include at least one material selected from the group consisting of a lithium transition metal oxide, such as cobalt acid lithium, nickel acid lithium, nickel cobalt acid lithium, nickel cobalt aluminum acid lithium, nickel cobalt manganese acid lithium, manganese acid lithium, and iron phosphate lithium, nickel sulfide, copper sulfide, sulfur (S), iron oxide, and vanadium oxide.

The binder may include at least one material selected from the group consisting of a polyvinylidene fluoride-based binder, such as polyvinylidene fluoride, vinylidene fluoride/hexafluoropropylene copolymer, or vinylidene fluoride/tetrafluoroethylene copolymer, a carboxymethyl cellulose-based binder, such as sodium-carboxymethylcellulose or lithium carboxymethylcellulose, an acrylate-based binder, such as polyacrylic acid, lithium-polyacrylic acid, acryl, polyacrylonitrile, polymethyl methacrylate, or polybutyl acrylate, polyamide-imide, polytetrafluoroethylene, polyethylene oxide, polypyrrole, lithium Nafion, and styrene butadiene rubber-based polymer.

The conductive agent may include at least one material selected from the group consisting of a carbon-based conductive agent, such as carbon black, carbon fiber, or graphite, conductive fiber such as metal fiber, carbon fluoride powder, metal powder, such as aluminum powder or nickel powder, conductive whisker, such as zinc oxide or potassium hexa-titanate, a conductive metal oxide, such as titanium oxide, and conductive polymer, such as a polyphenylene derivative.

The negative electrode current collector, in one or more embodiments, may include at least one metal selected from the group consisting of copper, stainless steel, nickel, and titanium. The negative electrode active material portion may include a negative electrode active material, a binder, and a conductive agent.

The negative electrode active material may be a material that may be alloyed with lithium or may reversibly absorb and discharge lithium. For example, the negative electrode active material may include at least one material selected from the group consisting of metal, a carbon-based material, metal oxide, and lithium metal nitride.

A metal of the negative electrode active material may include at least one material selected from the group consisting of lithium, silicon, magnesium, calcium, aluminum, germanium, tin, lead, arsenic, antimony, bismuth, silver, zinc, cadmium, mercury, copper, iron, nickel, cobalt, and indium.

The carbon-based material of the negative electrode active material may include at least one material selected from the group consisting of graphite, graphite carbon fiber, coke, mesocarbon microbeads (MCMB), polyacene, pitch-based carbon fiber, and hard carbon.

The metal oxide of the negative electrode active material may include at least one material selected from the group consisting of lithium titanium oxide, titanium oxide, molybdenum oxide, niobium oxide, iron oxide, tungsten oxide, tin oxide, amorphous tin complex oxide, silicon monoxide, cobalt oxide, and nickel oxide.

In one or more embodiments, the same binder and the same conductive agent as used in the positive electrode active material portion may be used as the binder and the conductive agent of the negative electrode active material.

The separator 116, in one or more embodiments, may be a porous polymer layer formed of at least one of polyethylene (PE), polystyrene (PS), and polypropylene (PP). For example, the separator 116 may be manufactured by coating a material selected from the group consisting of PE, PS, PP, and co-polymer of PE and PP with polyvinylidene fluoride-hexafluoropropylene (PVDF-HFP) co-polymer. However, embodiments of the present invention are not limited thereto. In one or more embodiments, the separator 116 may be formed to have a larger area than the first electrode plate 112 and the second electrode plate 114 so as to prevent or substantially prevent a short circuit between the first electrode plate 112 and the second electrode plate 114.

The electrode assembly 110 of the secondary battery 100 according to one or more embodiments may be formed in the form of a jelly roll, as illustrated in FIGS. 1 and 2. The electrode assembly 110 having the jelly roll shape may be formed as a multi-layer structure in which the first electrode plate 112, the second electrode plate 114, and the separator 116 are stacked, and then wound in the multi-layer structure into a jelly roll shape.

The jelly roll may be generally formed in the form of an oval having large eccentricity or in a track shape by applying external force from the center of the oval in a direction of a short axis of the oval. However, the shape of the jelly roll is not limited thereto, and any jelly roll shape that may be formed by winding the electrode assembly 110 may be used.

As illustrated in FIG. 1, a first lead 1120 and a second lead 1140 may be formed on the first electrode plate 112 and the second electrode plate 114, respectively.

The first lead 1120 and the second lead 1140 may be disposed on the first electrode plate 112 and the second electrode plate 114, respectively, so that the integrally-formed electrode tab 130 may be connected to the electrode assembly 110, and may be formed on ends of the first electrode plate 112 and the second electrode plate 114 in a lengthwise direction of the secondary battery 100.

The first lead 1120 and the second lead 1140 may be provided on the first electrode plate 112 and the second electrode plate 114, respectively, before the electrode assembly 110 is wound, and the electrode assembly 110 may be wound and formed in the form of the jelly roll in a state in which the first lead 1120 and the second lead 1140 are provided thereon.

Thus, as illustrated in FIG. 1, the first lead 1120 and the second lead 1140 may be provided to protrude from one end of the electrode assembly 110 having the jelly roll shape.

The shape of the first lead 1120 and the second lead 1140 is not limited in embodiments of the present invention. However, in one or more embodiments, the first lead 1120 and the second lead 1140 may be formed in the form of a rod having a length (e.g., a predetermined length) in the lengthwise direction of the secondary battery 100, as illustrated in FIG. 1.

Also, each of the first lead 1120 and the second lead 1140 may be a plate formed of the same material as a material used for forming the first electrode plate 112 and the second electrode plate 114.

That is, in one or more embodiments, as described above, the first electrode plate 112 and the second electrode plate 114 may be formed of aluminum, stainless steel, titanium, copper, nickel, or a combination of materials selected therefrom, and each of the first lead 1120 and the second lead 1140 may be formed of the same material as a material used for forming the first electrode plate 112 and the second electrode plate 114, respectively.

As illustrated in FIG. 1, the first lead 1120 and the second lead 1140 included in the secondary battery 100 according to one or more embodiments may be provided to be connected to a first electrode tab 131 and a second electrode tab 133, respectively, of the integrally-formed electrode tab 130.

A subminiature secondary battery having a small size among secondary batteries having a jelly roll-type electrode assembly has a narrow space and, thus, it is not easy to provide electrode tabs. Thus, the electrode tabs are attached onto an outer surface of the subminiature secondary battery.

The secondary battery 100 according to one or more embodiments of the present invention includes the first lead 1120 and the second lead 1140. Thus, the electrode tabs may be easily attached onto the outer surface of the electrode assembly 110.

That is, the secondary battery 100 according to one or more embodiments of the present invention includes the first lead 1120 and the second lead 1140 protruding from the electrode assembly 110. Thus, the first electrode tab 131 and the second electrode tab 133 may be easily connected to the first lead 1120 and the second lead 1140, respectively.

In one or more embodiments, the first electrode tab 131 and the second electrode tab 133 may be attached to the first lead 1120 and the second lead 1140, respectively, using welding.

In one or more embodiments, the first lead 1120 and the second lead 1140 may be formed to have a smaller thickness than the first electrode tab 131 and the second electrode tab 133, respectively. In this case, after the first electrode tab 131 and the second electrode tab 133 are attached to the first lead 1120 and the second lead 1140, respectively, the electrode assembly 110 having the jelly roll shape may have a uniform thickness.

The secondary battery 100 according to one or more embodiments may include the first electrode tab 131 and the second electrode tab 133, which are integrally formed with each other, as illustrated in FIG. 1.

In one or more embodiments, the first electrode tab 131 and the second electrode tab 133 may be formed integrally with each other using a polymer film 135 formed of a PP material, and the first electrode tab 131 and the second electrode tab 133 may be connected to the first lead 1120 and the second lead 1140 of the jelly roll-type electrode assembly 110, respectively.

In this case, a problem of position dispersion that may occur when each of the first electrode tab 131 and the second electrode tab 133 is connected to the electrode assembly 110 may be prevented or substantially prevented.

As described above, the subminiature secondary battery has a narrow space in a sealing portion so that the electrode tabs may not be easily disposed in the secondary battery and thus may be formed on the outer surface of the secondary battery. In this case, when the electrode tabs are formed on the outer surface of the secondary battery, a problem related to an increase in position scattering of the electrode tabs may occur.

That is, when a first electrode tab and a second electrode tab are not integrally provided but are separately provided, as generally used, position dispersion between electrode tabs may be increased while the electrode tabs are connected to the electrode assembly and the electrode assembly is wound in the form of the jelly roll.

However, in the secondary battery 100 according to one or more embodiments of the present invention, the integrally-formed electrode tab 130 having a multi strip terminal (MST) structure is connected to the wound jelly roll-shaped electrode assembly 110 so that the problem related to the increase in position dispersion may be prevented or substantially prevented.

That is, in the secondary battery 100 according to one or more embodiments of the present invention, when the integrally-formed electrode tab 130, in which the first electrode tab 131 and the second electrode tab 133 are integrally formed with each other, is connected to the electrode assembly 110, a distance between the first electrode tab 131 and the second electrode tab 133 and a position of each of the first electrode tab 131 and the second electrode tab 133 are fixed such that position dispersion of the integrally-formed electrode tab 130 may be prevented or reduced.

That is, in the secondary battery 100 according to one or more embodiments of the present invention, the integrally-formed electrode tab 130, in which the distance between the first electrode tab 131 and the second electrode tab 133 and the position of each of the first electrode tab 131 and the second electrode tab 133 are fixed, is used such that the integrally-formed electrode tab 130 in the subminiature secondary battery is provided on the outer surface of a sealing portion 210 and the efficiency of space use may be improved and the problem related to the increase in position dispersion of one or more electrode tabs disposed outside the subminiature secondary battery may be prevented or reduced.

Also, the sealing portion 210 and the integrally-formed electrode tab 130 may be sealed using the polymer film 135 formed of the PP material.

In the secondary battery 100 according to one or more embodiments of the present invention, the integrally-formed electrode tab 130 is not directly connected to the jelly roll-shaped electrode assembly 110, but the first lead 1120 and the second lead 1140 are primarily (e.g., directly) connected to the electrode assembly 110 such that the integrally-formed electrode tab 130 may be connected to the first lead 1120 and the second lead 1140.

If the integrally-formed electrode tab 130 is directly connected to the electrode assembly 110, the jelly roll-shaped electrode assembly 110 may not be continuously wound while being formed. That is, the first electrode tab 131 and the second electrode tab 133 are connected to each other such that they may not be connected to the electrode assembly 110 individually.

In the secondary battery 100 according to one or more embodiments of the present invention, the first lead 1120 and the second lead 1140 are primarily (e.g., directly) connected to the electrode assembly 110 such that, after the electrode assembly 110 is wound and is formed in the form of the jelly roll, the integrally-formed electrode tab 130 may be directly connected to the protruding first lead 1120 and the protruding second lead 1140.

Thus, the integrally-formed electrode tab 130 may be connected to the jelly roll-shaped electrode assembly 110 by the first lead 1120 and the second lead 1140 that are primarily connected to the jelly roll-shaped electrode assembly 110.

An electrolyte together with the electrode assembly 110 is accommodated in the sealing portion 210.

In the secondary battery 100 according to one or more embodiments of the present invention, for convenience of explanation, a pouch having a space that accommodates the electrode assembly 110 is described herein, as illustrated in FIGS. 1 and 2. However, embodiments of the present invention are not limited thereto. That is, the shape of the sealing portion 210 is not limited thereto, and any other type of sealing portion, for example, an angular case may be used as a container for accommodating the electrode assembly 110.

The sealing portion 210, in one or more embodiments, may include a first sealing portion 211 having an accommodation space 2110 for accommodating the electrode assembly 110, and a second sealing portion 213 that covers the accommodation space 2110 and is bonded to the first sealing portion 211 at edges of the accommodation space 2110.

The accommodation space 2110 may be formed using press working. Also, a hole (not shown) for discharging gas generated in a coke manufacturing process of the secondary battery 100 may also be additionally formed in a lateral direction of the accommodation space 2110.

The second sealing portion 213 may be bonded to the first sealing portion 211 and may seal the sealing portion 210 after the electrode assembly 110 is accommodated in the accommodation space 2110.

Each of the first sealing portion 211 and the second sealing portion 213 may include a first insulating layer, a metal layer, and a second insulating layer, which are sequentially stacked on one another in this order. The first insulating layer and the second insulating layer may be formed of PP, polyethylene terephthalate (PET), or nylon, and the metal layer may be formed of aluminum, steel, or stainless steel. However, embodiments of the present invention are not limited thereto. For example, the first sealing portion 211 and the second sealing portion 213 may have a three-layer structure including the first insulating layer formed of PP, the metal layer formed of aluminum, and the second insulating layer formed of PET.

One side of the first sealing portion 211 and one side of the second sealing portion 213 may be consecutively formed. If the electrode assembly 110 is placed in the accommodation space 2110, the second sealing portion 213 is folded on the first sealing portion 211 and, then, the first sealing portion 211 and the second sealing portion 213 may be melted and bonded to each other at edges of the accommodation space 2110 and may seal the sealing portion 210.

As described above, the first electrode tab 131 and the second electrode tab 133 may be drawn to the outside through a space between the first sealing portion 211 and the second sealing portion 213 bonded to each other. In order to improve a bonding force between the first sealing portion 211 and the second sealing portion 213 and to prevent or substantially prevent a short circuit between the first electrode tab 131 and the second electrode tab 133, an insulating tape (not shown) may be attached to an outer surface of the first electrode tab 131 and an outer surface of the second electrode tab 133.

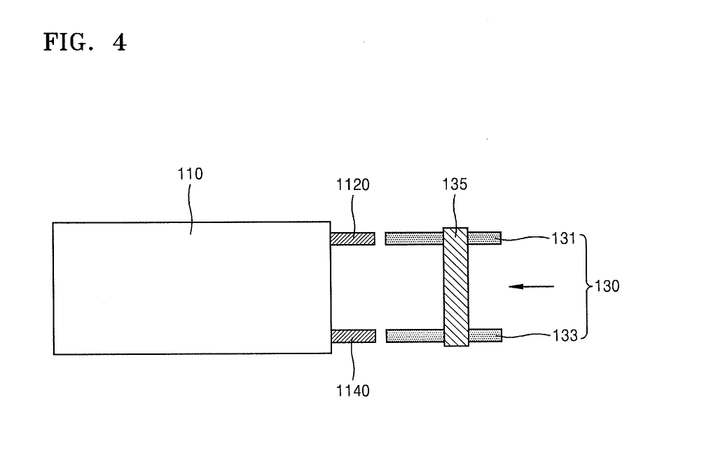

That is, in the subminiature secondary battery, forming the integrally-formed electrode tab 130 in the sealing portion 210 is difficult due to a narrow space. Thus, as illustrated in FIG. 4, the first lead 1120 and the second lead 1140 may be formed to primarily protrude from the jelly roll-shaped electrode assembly 110, and the integrally-formed electrode tab 130 may be connected to the jelly roll-shaped electrode assembly 110.

Thus, the first electrode tab 131 and the second electrode tab 133 may be formed to be drawn to the outside of the sealing portion 210, as illustrated in FIG. 1.

As described above, in the secondary battery 100 according to one or more embodiments of the present invention, the first electrode tab 131 and the second electrode tab 133 may be connected to the first lead 1120 and the second lead 1140 such that the integrally-formed electrode tab 130 in which the first electrode tab 131 and the second electrode tab 133 are integrally formed with each other, may be drawn to the outside of the sealing portion 210.

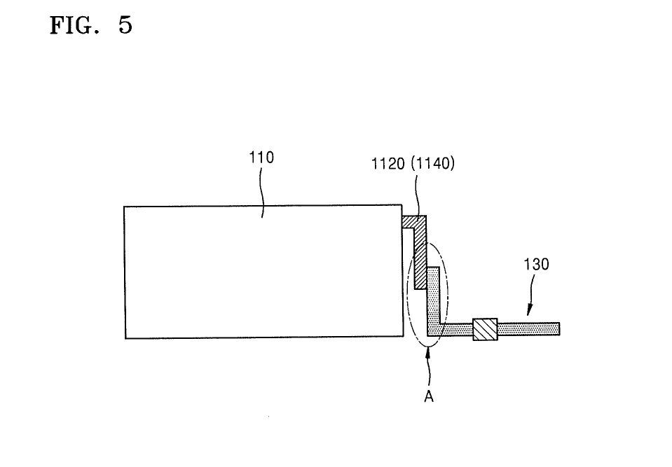

One end of the first electrode tab 131 and one end of the second electrode tab 133 may be drawn to the outside of the sealing portion 210, as described above, and a bending portion “A” (see FIG. 5) may be formed on the other end of the first electrode tab 131 and the other end of the second electrode tab 133, respectively, which are connected to the first lead 1120 and the second lead 1140.

A part of the first electrode tab 131 and a part of the second electrode tab 133 each having the bending portion “A” formed thereon may be placed in the sealing portion 210. As the bending portion “A” (see FIG. 5) is formed on the integrally-formed electrode tab 130, a space in the sealing portion 210 may be utilized.

Also, due to the bending portion “A” being formed, vibration resistance may be improved. That is, when the jelly roll-shaped electrode assembly 110 moves, the bent electrode tab 130 may serve as a spring, may withstand vibration, and may prevent or substantially prevent the integrally-formed electrode tab 130 from being disconnected.

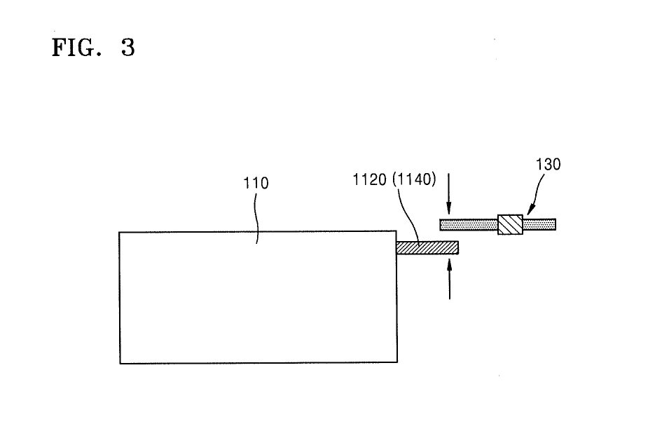

FIGS. 3 and 4 are schematic views showing a method of manufacturing a secondary battery, according to an exemplary embodiment of the present invention. FIG. 3 is a schematic side view of the electrode assembly 110 having a jelly roll shape of the secondary battery 100 of FIG. 1; and FIG. 4 is a schematic top view of the electrode assembly 110 illustrated in FIG. 3.

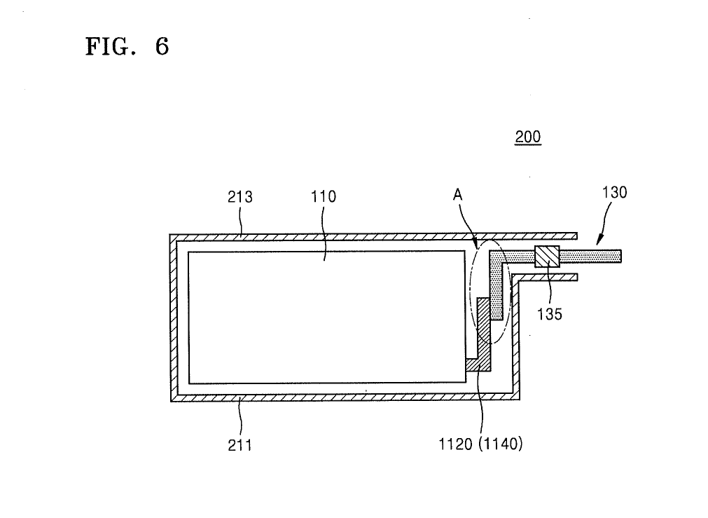

FIGS. 5 and 6 are schematic side views of an electrode assembly and a secondary battery, respectively, according to another exemplary embodiment of the present invention. In FIGS. 3 through 6, like reference numerals used in FIGS. 1 and 2 represent like elements, and a redundant description thereof will be omitted for simplification of explanation.

Hereinafter, the method of manufacturing the secondary battery, according to some exemplary embodiments, will be described in further detail, though one or more of the tasks described may not necessarily be performed in the order set forth below.

First, a multi-layered electrode assembly may be prepared by stacking the first electrode plate 112, the second electrode plate 114, and the separator 116 between the first electrode plate 112 and the second electrode plate 114.

Next, the first lead 1120 and the second lead 1140 each having a length (e.g., a predetermined length) may be formed in the first electrode plate 112 and the second electrode plate 114 in the lengthwise direction of the secondary battery.

The first lead 1120 and the second lead 1140 may be formed to have a length (e.g., a predetermined length) at edges of the first electrode plate 112 and the second electrode plate 114 to protrude toward the outside of the electrode assembly 110 and may be formed in the form of a rod or plate, as illustrated in FIGS. 3 through 6. However, the shape of the first lead 1120 and the second lead 1140 is not limited thereto, and any type of the first lead 1120 and the second lead 1140 that may be primarily attached onto the first electrode plate 112 and the second electrode plate 114 may be used.

Also, each of the first lead 1120 and the second lead 1140 may be formed of the same electrode material as those of the first electrode plate 112 and the second electrode plate 114.

Next, the first electrode plate 112 onto which the first lead 1120 is attached, the second electrode plate 114 onto which the second lead 1140 is attached, and the separator 116 are wound such that the electrode assembly 110 having a jelly roll shape may be formed.

Next, referring to FIGS. 3 and 4, the first electrode tab 131 and the second electrode tab 133 may be connected to the first lead 1120 and the second lead 1140, respectively, which are formed to protrude toward the jelly roll-shaped electrode assembly 110. In this case, the first electrode tab 131 and the second electrode tab 133 may be formed as the integrally-formed electrode tab 130.

Next, the electrode assembly 110 may be sealed by the sealing portion 210, and a part of the integrally-formed electrode tab 130 may be arranged outside the sealing portion 210 in the subminiature secondary battery.

In a secondary battery 200 according to another exemplary embodiment, referring to FIGS. 5 and 6, the bending portion “A” may be formed on one side of the first electrode tab 131 and one side of the second electrode tab 133, respectively, which are connected to the first lead 1120 and the second lead 1140.

That is, after the first electrode tab 131 and the second electrode tab 133 are connected to the first lead 1120 and the second lead 1140, the bending portion “A” may be formed on the integrally-formed electrode tab 130 before the electrode assembly 110 is sealed in the sealing portion 210. This increases or maximizes space efficiency by utilizing a space in the sealing portion 210, as described above.

Next, referring to FIG. 6, the electrode assembly 110 is placed in the first sealing portion 211 having the accommodation space 2110 formed therein, and the second sealing portion 213 that covers the accommodation space 2110 and is formed as a plate shape, is placed at an upper portion of the electrode assembly 110 and thus is bonded to the first sealing portion 211 at edges of the accommodation space 2110 so that the electrode assembly 110 may be sealed in the sealing portion 210.

As described above, according to one or more embodiments of the present invention, in a subminiature secondary battery, electrode tabs may be formed outside the subminiature secondary battery using a first lead and a second lead that are primarily connected to an electrode assembly. Also, position dispersion of the electrode tabs may be prevented or reduced by using an integrally-formed electrode tab.

It should be understood that the exemplary embodiments described herein should be considered in a descriptive sense only and not for purposes of limitation. Descriptions of features or aspects within each exemplary embodiment should typically be considered as available for other similar features or aspects in other embodiments.

While one or more exemplary embodiments have been described with reference to the figures, it will be understood by those of ordinary skill in the art that various changes in form and details may be made therein without departing from the spirit and scope as defined by the following claims and equivalents thereof.

What is claimed is:

1. A secondary battery comprising:
an electrode assembly comprising a first electrode plate, a second electrode plate, and a separator between the first electrode plate and the second electrode plate;
a first lead and a second lead on one end of the first electrode plate and one end of the second electrode plate, respectively; and
a first electrode tab and a second electrode tab connected to the first lead and the second lead, respectively,
wherein the first electrode tab and the second electrode tab are integral with each other.

2. The secondary battery of claim 1, wherein the electrode assembly is wound and has a jelly roll shape.

3. The secondary battery of claim 1, wherein each of the first lead and the second lead comprises a same material as a material of the first electrode plate and the second electrode plate, respectively.

4. The secondary battery of claim 1, wherein the first electrode tab and the second electrode tab are integrally connected to each other through a polymer film.

5. The secondary battery of claim 1, wherein each of the first lead and the second lead has a smaller thickness than that of the first electrode tab and the second electrode tab.

6. The secondary battery of claim 1, further comprising a sealing portion accommodating the electrode assembly, wherein the sealing portion comprises a first sealing portion having an accommodation space to accommodate the electrode assembly, and a second sealing portion that covers the accommodation space and is coupled to the first sealing portion.

7. The secondary battery of claim 6, wherein the first electrode tab and the second electrode tab are protruded to the outside of the sealing portion in a sealed state.

8. The secondary battery of claim 1, wherein each of the first electrode tab and the second electrode tab comprises a bending portion in a bent shape, and the bending portion is arranged in the sealing portion.

9. A method of manufacturing a secondary battery, the method comprising:
providing a first electrode plate, a second electrode plate, and a separator between the first electrode plate and the second electrode plate;
arranging a first lead and a second lead on the first electrode plate and the second electrode plate, respectively, in a lengthwise direction of the secondary battery;
preparing an electrode assembly having a jelly roll shape by winding the first electrode plate, the second electrode plate, and the separator; and
connecting a first electrode tab and a second electrode tab to the first lead and the second lead, respectively,
wherein the first electrode tab and the second electrode tab are integral with each other.

10. The method of claim 9, wherein each of the first lead and the second lead comprises a same material as a material of the first electrode plate and the second electrode plate, respectively.

11. The method of claim 9, wherein the first electrode tab and the second electrode tab are integrally connected with each other using a polymer film.

12. The method of claim 9, further comprising bending the first electrode tab and the second electrode tab that are integral with each other, after the first electrode tab and the second electrode tab are connected to the first lead and the second lead, respectively.

13. The method of claim 9, further comprising:
providing a sealing portion having an accommodation space;
placing the electrode assembly, the first lead, and the second lead in the accommodation space; and
sealing the sealing portion such that the first electrode tab and the second electrode tab protrude outside the sealing portion.
